(19) United States
(12) Patent Application Publication
(10) Pub. No.: US 2009/0216549 A1
(43) Pub. Date: Aug. 27, 2009

(54) Gift Registry and Comparison Shopper

(75) Inventors: Mark Edward Causey, Tucker, GA (US); Adrianne Binh Luu, Roswell, GA (US); Scott Andrus, Prior Lake, MN (US); Kevin Wray Jones, St. Louis Park, MN (US)

Correspondence Address: AT&T Legal Department - Moazzam;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/038,571

(22) Filed: Feb. 27, 2008

(51) Int. Cl. G06Q 99/00

(52) U.S. Cl. 705/1

(57) ABSTRACT

Devices and methods are disclosed which relate to the creation of a gift registry or comparison shopper. A user can select any product from any store using her mobile communications device and add it to her registry. This registry can be viewed online so that the user as well as guests can view it and select products to purchase.

### BACKGROUND OF THE INVENTION

1. Field of the Invention

The present invention relates to gift registries. More specifically, the present invention relates to using devices to select products from any store for creation of a gift registry.

2. Background of the Invention

Over the past two decades, the advent and advancement of electronics and the Internet has allowed new tools to be created that ease the burden of conventional tasks. Among such new tools are gift registries, for example bridal registries, which are very useful shopping tools that are frequently used by department stores to help facilitate purchases of various products for special occasions. In the case of bridal registries, a couple generally chooses items from a store and indicates the number of each item they would like to receive as gifts. The department store, or merchant, keeps a list of these items at the store so that individuals looking to purchase gifts for the couple know which gifts to buy.

With most gift registries, as a gift is purchased for the recipient who created the list, the item is removed from the list or marked as already purchased. Before a buyer makes a purchase at a store at which the recipient is registered, the merchant is able to check the registry and confirm that the item has not already been purchased. Many of these gift registries are now online as well as in the store itself. With online registries, potential gift buyers can see the list of desired items, which gifts have already been purchased, and what remains on the list. This can prevent the duplication of gifts. The online registries also allow users to purchase gifts online. However, these registries are often limited to one store.

Another useful new tool is the ubiquitous mobile device, such as mobile telephones, which are another common tool for communication in today's society. Currently, there are roughly 3.3 billion mobile telephone subscribers in the world. Around 80% of the world enjoys mobile telephone coverage. As the technology in the field grows, the capabilities of these telephones are greatly increasing as well. Many of these mobile phones allow for text messaging, e-mail, and internet access. It is also very common for a phone to be able to take pictures which can then be sent to other phones or computers.

What is needed is a system that allows a user with a mobile phone or other mobile device to take advantage of the portability of the mobile device and use it to ease the routine of creating and/or purchasing from a database or gift registry.

### SUMMARY OF THE INVENTION

The present invention is a gift registry and/or comparison shopper. A user may enter any store and select products to enter into a registry by using a mobile communications device. The products are selected by scanning the product's barcode or RFID chip, or by taking a picture of the product. The data is sent to a server which creates the registry. A user can also compare a product with similar alternatives. The user selects the products in the same way as the gift registry but uses the output of the server for comparison purposes rather than a gift registry.

In one exemplary embodiment, the invention is a gift registry comprising a mobile communication device, wherein the mobile communication device is used to capture the identity of a product; a server, wherein the mobile communication device uploads the identity of the product to the server; and a database linked to the server, wherein the database contains a variety of pricing and product information.

In another exemplary embodiment, the invention is a method of creating a gift registry. The method includes the steps of signing up for a registry service; capturing an identity of a product which a user desires to add to the user's registry, wherein the capturing is accomplished with a mobile device; and uploading the identity of the product to a server.

### BRIEF DESCRIPTION OF THE DRAWINGS

FIG. 1 shows a flowchart of a system utilized to add items to a registry, according to an exemplary embodiment of the present invention.

FIG. 2 shows selection of an item, according to an exemplary embodiment of the present invention.

FIG. 3 shows use of the system by the registered party or a potential gift purchaser, according to an exemplary embodiment of the present invention.

FIG. 4 shows a flowchart outlining a use of a registry, according to an exemplary embodiment of the present invention.

FIG. 5 shows a list of items on a registry, according to an exemplary embodiment of the present invention.

FIG. 6 shows a display of an item's information, according to an exemplary embodiment of the present invention.

FIG. 7 shows a notification system of the present invention, according to an exemplary embodiment of the present invention.

FIG. 8 shows a notification received by a user, according to an exemplary embodiment of the present invention.

### DETAILED DESCRIPTION OF THE INVENTION

The present invention is a gift registry and/or comparison shopper. The invention allows a user to enter any store and enter products into a registry via a mobile communications device. The products are selected by various techniques, including but not limited to, scanning the barcode or RFID chip associated with the product, or taking a picture of the product with the mobile communications device. The data is then sent to a server that creates the registry. A user can also select products in order to compare the product with other similar items. The user selects the products in the same way as the gift registry but uses the output of the server for comparison purposes rather than a gift registry.

A “mobile communication device,” as used herein and throughout this disclosure, refers to a wireless device used for communication that requires a battery or other independent form of energy for power. This includes devices such as a cellular telephone, personal digital assistant (PDA), portable computer, pager, etc. A “network operator/service provider” is usually a telephone or other company that provides services for mobile phone subscribers. A “user,” as used herein and through this disclosure, refers to a person or device that utilizes the registry or comparison shopper, either as a potential gift purchaser or the intended recipient of the gifts. A “Registered Party” is a person who has registered to have a gift registry created for him or her. This person is the intended recipient of the gifts purchased. A “merchant” is any seller of goods or services, either online or in a traditional store.

In an exemplary embodiment of the invention, a user who wishes to register with a gift registry accesses the gift registry website. The user may access the website via a mobile communications device, or any other device capable of accessing a network. The site may be hosted on the Internet, a corporate intranet, or any local or wide area network. In one embodiment, the website is hosted by a mobile operator and is accessible via a mobile communications device.

Upon accessing the website, the user signs up for the service which utilizes the present invention. In an embodiment of the invention, the sign up is accomplished by providing a valid e-mail address, or other username, and a selected password. The user may also request that the service be provisioned by the service provider or operator. Alternatively, the service may be automatically provisioned for the user as soon as the system detects that a gift registry is to be created. This can be done simply by downloading and installing the gift scanner on a mobile communications device. In either case, once signed in, the user may choose from options related to appearance and use of the system. For example, the user may choose from a variety of appearances for the gift registry website. The user may also add a list of e-mail addresses she wishes an e-mail to be sent to regarding the gift registry. The user may also select notification options such that she will be notified of specific events.

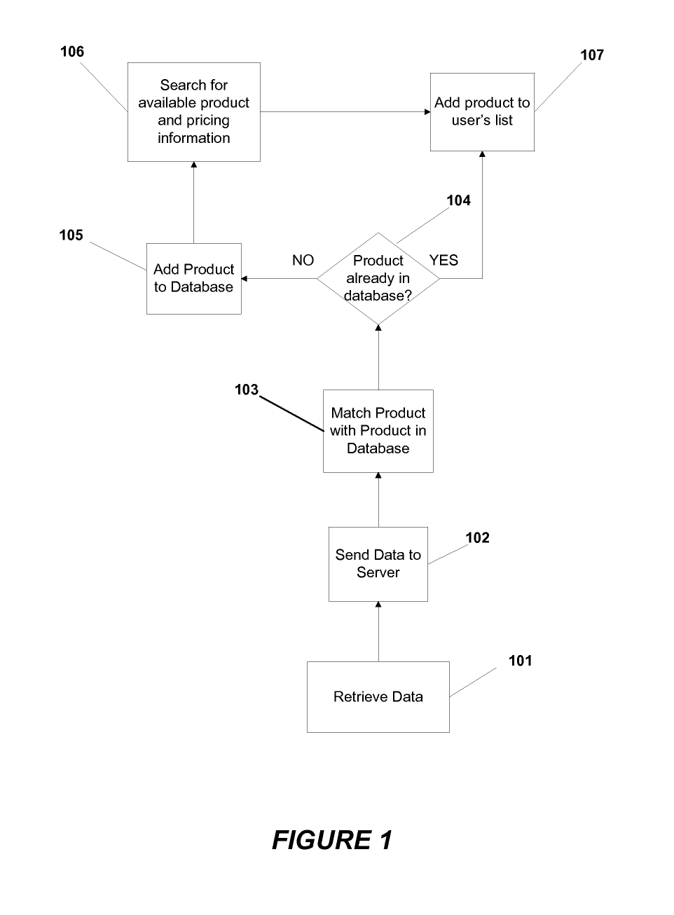

FIG. 1 shows a flowchart of an exemplary embodiment of the system used to add items to a registry. When a user wishes to add a product to the registry, the user first captures data (101) about the product using a cellular phone or other mobile communication device. This device can be their own or given to them by a participating merchant. In one embodiment, the captured data is in the form of a digital photograph taken of the product or product's bar code or price tag. Alternatively, the cellular phone or mobile communication device scans the barcode of the item. This could be a device equipped with a bar code scanner as described herein. This could also include a logic unit on the device that connects to a database on the device or on a server on the network to retrieve pricing information for a product. In a further embodiment, the product or price tag could contain an RFID chip which the cellular phone or mobile device identifies. Each of these is a method of retrieving the product's data. The captured data is sent to a server (102). The server next attempts to match the item with its product information from a database of items (103). In the case of a digital photograph, this may be accomplished with picture recognition software or by embedding a code in the picture. RFID or barcode data are matched with data on the server. With this data, the system determines whether or not the product is in the server's database (104). If a match is available in the system, the product is added to the registry list for the user (107). Any new pricing information for the product is updated in the database. If a match is not found in the database, the item is added to the database (105). Software on the server will search for product information as well as pricing information, possible alternatives, and new models or upgrades (106). In an exemplary embodiment of the invention, this is accomplished by searching the internet and available databases. Any information on the item will be matched with the item now in the database. The item is then added to the registry list for the user (107).

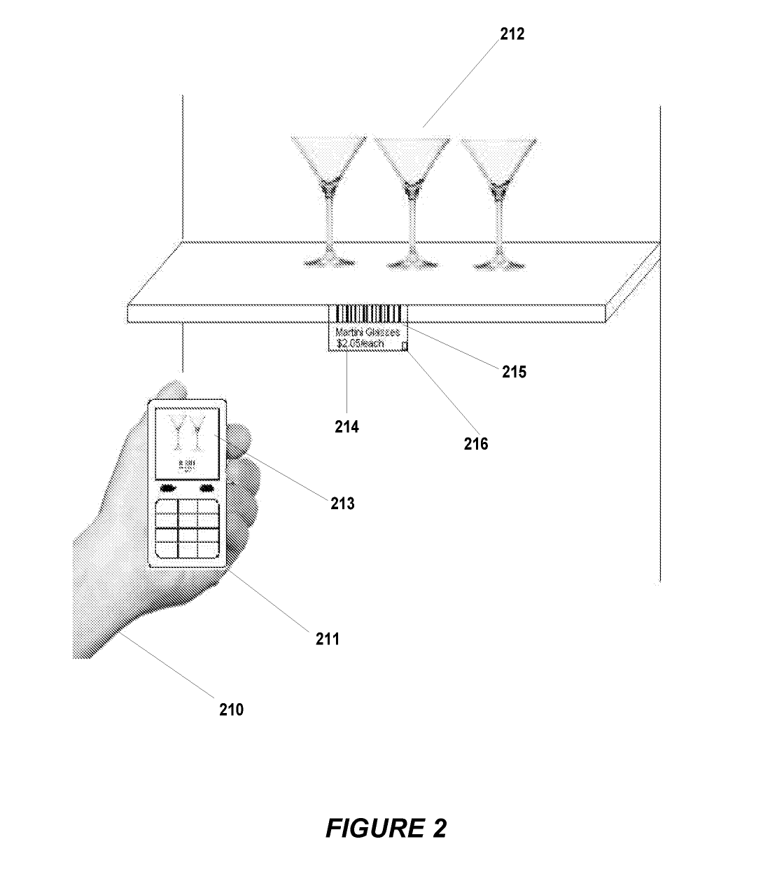

FIG. 2 shows the selection of an item, according to an exemplary embodiment of the present invention. In this embodiment, a user 210 enters a store and chooses items which she would like to add to her gift registry. The user utilizes the camera on her mobile phone 211 to take a picture 213 of the desired item 212. The user (or the logic unit on device 211) sends the picture 213 to the server along with the quantity of the item 212 desired. This picture is matched to the database such that the exact identity of the item is determined. This can be achieved by software similar to facial recognition software. The logic unit that sends the picture may be an application on device 211, or may simply be a web browser that allows user 210 to access the web interface described above. Alternatively, the logic unit may submit the photo to a server on the network that compares the photo to a product database. For instance, user 210 would like to add martini glasses 212 to her gift registry. By taking a picture of martini glass 212, using device 211 and hitting “send”, the picture is sent and matched with a database on the network. Alternatively user 210 is presented with a web-based interface to upload the photo to the server where it is subsequently processed. Other methods of submitting the information will be apparent to one skilled in the art and are within the scope of the present invention.

In an alternate embodiment, the mobile phone is used to scan or take a picture of the barcode 215 of the item. This is accomplished with the user's mobile phone 211 that is equipped with a bar code scanner. This could be an aftermarket scanner provided by a merchant, third-party vendor, or service provider. Alternatively, this could be the same service provider that operates the mobile network that the user subscribes to, thus the mobile device may be provided by the network operator. User 210 or device 211 then sends the barcode data to the server, which interprets and matches the data with available data in the database. Alternatively, user 210 scans an RFID tag 216, located on the price tag 214 or elsewhere on the item, using her device 211 or a mobile device provided by the store. RFID tag 216 communicates the product's identity to the mobile phone 211.

In each of these embodiments, the server can update pricing information on each item based on the data received. For instance, user 210 carrying barcode scanner 211 enters a Macy's store and comes across martini glasses 212. User 210 scans barcode 215 using device 211. This barcode contains the current price for product 212. The database on the network containing all product details is updated to reflect that the specific martini glasses at Macy's currently cost $2.05 each. Constantly updating the price for each product by combining data submitted by multiple users nationwide creates an almost real-time price comparison guide, thus recommendations to other users buying the same product are current and accurate.

A further embodiment of the invention allows anyone to upload images to the server. This could require a password distributed to guests or be open to anyone. For instance, a guest could walk into Macy's, be handed a barcode scanner, or be carrying a mobile device with a camera. The guest could be browsing the registry to find a gift, and come across a gift similar to martini glasses 212. The guest would scan the item or take a picture. The picture is uploaded to the server. Included with the images can be questions for the registered party/recipient. For instance, the guest could tag the image with the question: “Is this the product you wanted?” or “Do you like this product better?” The registered party/recipient may respond to the questions through the website or text message, allowing an ideal gift to be purchased.

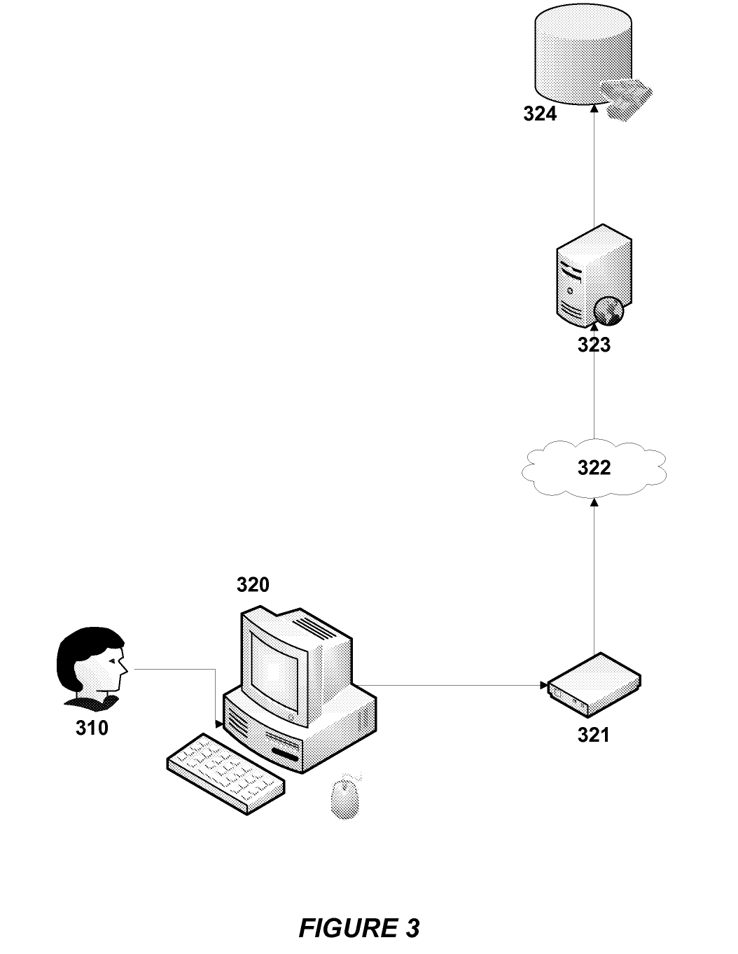

FIG. 3 shows an exemplary embodiment of a use of the system by the registered party or a potential gift purchaser. In this embodiment, a user 310 of the system utilizes a computer 320 or other device that can access a wired or wireless network 322, such as a mobile network, WAN, or the Internet. For instance, computer 320 may connect to the Internet 322 via a modem 321. A server 323 hosts a website for the gift registry and allows the user 310 to access the website over the internet 322. Server 323 may reside on the Internet, or on a separate network that is connected to the internet. A database 324 is connected to the server 323, and contains information about each item in each gift registry as well as information about various products. This information can be derived from catalogs or inventory lists provided by retailers or merchants. Alternatively this information can be tracked from websites such as Amazon, eBay, as well as online store catalogs.

In the case of the potential gift purchaser, when the user connects with the website through the Internet 322, she can load the recipient's registry by selecting the recipient from a list or by entering their name. The user (in this case, the guest) will be able to view the latest additions to the registry, as well as upload their own pictures/ideas for gifts. This is an example of how the website may be used to communicate between the recipient and her guests. A messaging system may also be present on the website. When the recipient of registered party connects with the gift registry website, she can log into her account. This allows the recipient to update her item list, including allowing her to select new products from a list in the database, through websites, or enter her own product. She will also be able to add guest recommended items to her registry, or respond to messages from guests regarding items on the list.

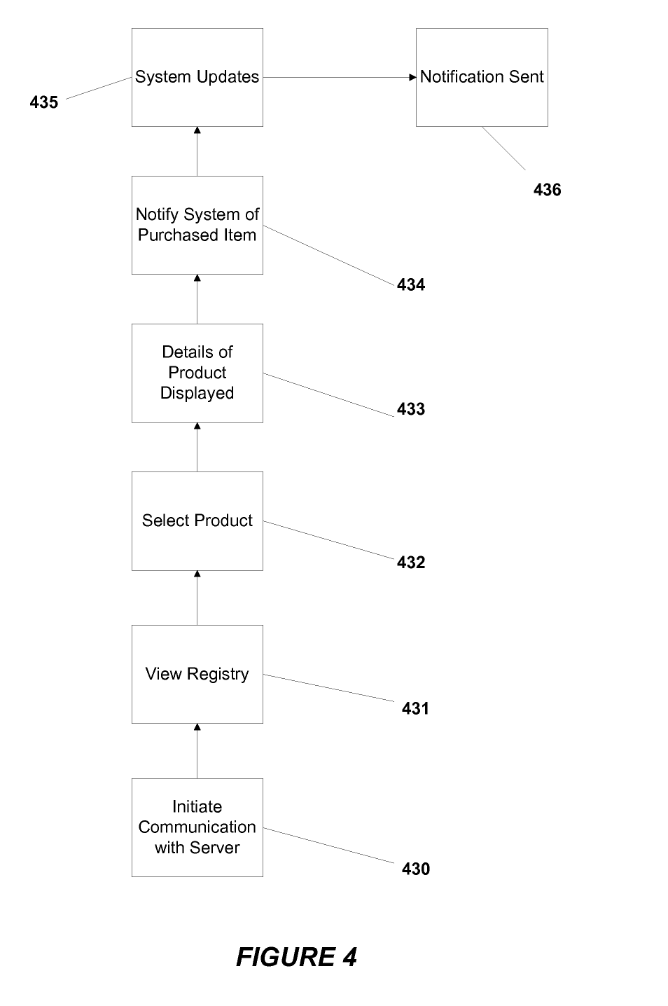

FIG. 4 shows a flowchart outlining use of a registry, according to an exemplary embodiment of the present invention. A user, either the future recipient or a gift purchaser/guest, initiates communication with the server (430) by logging in to the registry website. For the recipient, logging in may include entering a username and password. For the guests, logging in may require a username and password or may only entail selecting the desired recipient from a list. In one embodiment, the recipient authorizes all invited guests with registered accounts. Once logged in, the user views the registry (431). The registry will display a list of items which the recipient had previously selected. If the user is the creator of the list, the user may select to add items to the list. This may be done by selecting an item or items from the database or may entail adding an item from a merchant, possibly from another website. From the list of items in the registry, any user can select one of the items (432). Once selected, the website shows details of the product (433). These details include the quantity of the product desired, the best price and retailer offering that price, possible alternatives or upgrades to the item, as well as general information about the product. On this detail page, or on the list of items in the registry, the user may notify the system that the item has already been purchased (434). This step may be automated in the event that the user purchases from a link from the website or if the user purchases the item from a participating retailer. When the system is notified of a purchase, it updates the database (435) and the item in the registry list is checked off. This will signal to other users that the item has already been purchased and that they should purchase a different item from the list. If the recipient has requested more than one quantity of an item, the number of the item that have not yet been purchased will remain for all users to see.

In an exemplary embodiment of the invention, a notification will be sent to the registered party (436), detailing the item checked off as well as the number remaining. This notification can be sent as an e-mail, text message, automated telephone call or any other form of electronic communication known in the art. Alternatively, the recipient may periodically check the website manually. In another embodiment, notifications can be sent (436) to the potential gift purchasers who have registered, detailing the items bought. This notification could be sent by e-mail, text message, automated telephone call, etc. These notifications can serve to inform the parties which items have been purchased and which remain so that duplicate gifts will not be purchased.

In a further embodiment, participating stores detect the presence of either the recipient or potential gift buyers and text the person when they enter the store to inform them of remaining items on the registry. The detection can be accomplished in many ways, including using, for example, BLUETOOTH technology or Assisted GPS (AGPS). A BLUETOOTH-activated device identifies the user, so that when the user enters the store, the gift registry for the recipient is activated on the user's device. In the case of AGPS, the device owner or user's presence at a particular retail outlet triggers a response in the gift registry server. In one embodiment, the server on the mobile network may inform the store, via the internet or any other network, that a potential gift purchaser has entered the store. At this point, the merchant may offer the user an updated gift registry. Alternatively, the server may simply forward an updated copy of the registry to the user. This could happen via an SMS text or other similar messaging protocol. For example, a user that has been signed up for text message notifications can walk into a participating store. Her presence is detected by the store and a text message will be sent to her. The text message may include a list of items available at the store, for instance Martini Glasses for $2.05 each, and notifies the user of the items still needed on the list. Alternatively, depending on the user's device, the text message could simply provide a notification that gift-registry items are available in the store, and provide a web or WAP link to the website containing the list. The user will then know how many martini glasses to purchase such that there will not be duplicate gifts.

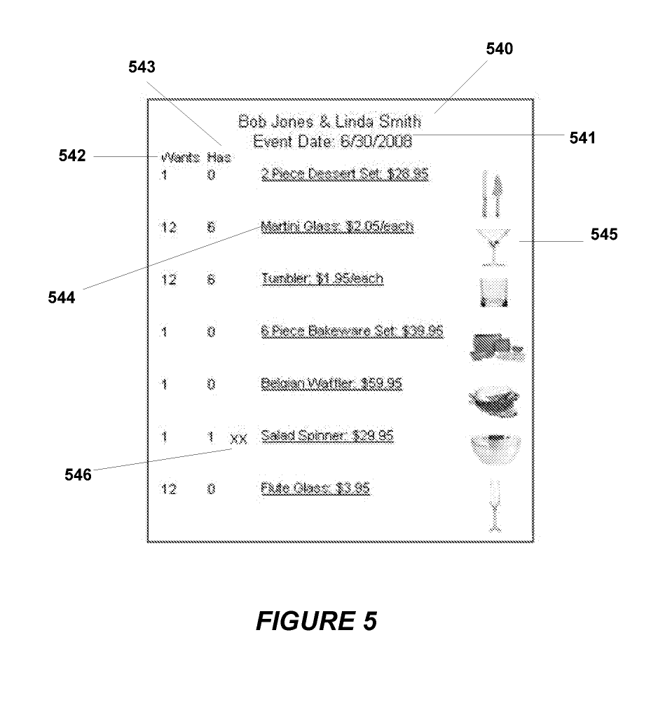

FIG. 5 shows a list of items on a registry, according to an exemplary embodiment of the present invention. In this embodiment, the name of the registered party 540 and the date of the event 541 are listed. Each of the items selected by the registered party appears on the screen. Beside each of the listed items are columns stating the quantity desired 542 and the quantity that has already been purchased 543. When the total desired quantity of an individual item has been purchased, the screen notifies the user of this fact. This may be accomplished in such ways as putting a check or X mark 546 next to the item or changing the text color of an item. The user may select a product, such as the martini glass 544, by clicking on the name of the product and will be transferred to a more detailed description of that product. Alternatively, when the user clicks on the name or scrolls over the name, a new window is formed on the screen with a more detailed description of the product. From the list of items, the user may mark that she has purchased an item. This could be accomplished by clicking on the number purchased, checking a box, clicking a purchased button, or any other way. This will update the count of the number purchased and, in the event it is the last of the item desired, put a notification of this on the page. The figure further shows a picture 545 of each product. In an embodiment of the present invention, clicking on the picture 545 also brings up a more detailed description of the product.

The list of products in the registry can be arranged in various logical ways. In one embodiment, the products are in alphabetical order. In other embodiments, the products may be organized by type. For example, glassware is all grouped together, electronics are all grouped together, and so forth. In another embodiment, the products are sorted by price and listed from low price to high price or vice versa. In further embodiments, the initial screen of the registry only lists these groups or lists individual price ranges. The user selects one of these, such as by clicking on the link, and is taken to a new page listing the products in the category selected.

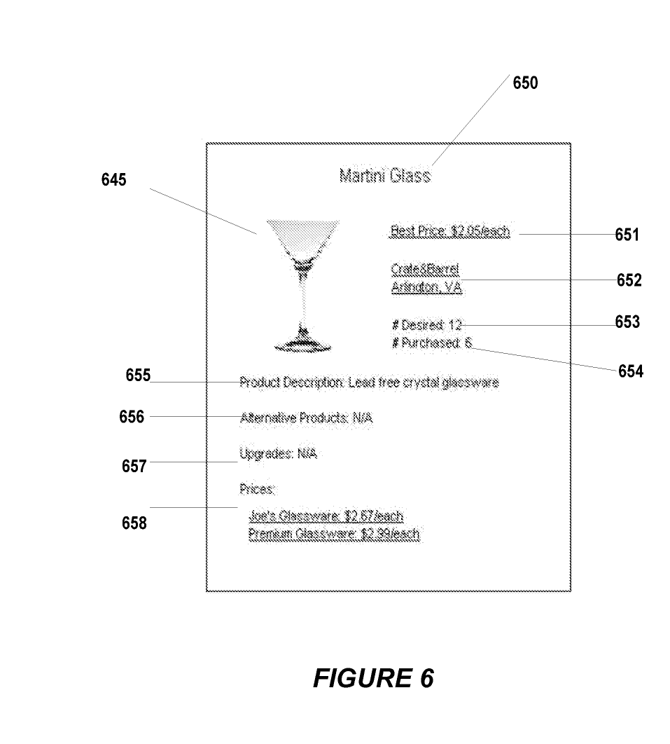

FIG. 6 shows an exemplary embodiment of a display of an item's information. In this embodiment, the screen displays a picture 645 of the item along with the price 651 and store where the item is available 652. This price may be the price of the item from the store at which it was selected or may be the best price available from merchants within the database. The screen also displays the name 650 of the item as well as a description 655 of the item. The description includes the features of the item and may also include products that may be alternatives 656 to the item, available upgrades 657 to the item, and alternative prices 658 and the merchants where the item can be purchased. The screen may contain links to the websites of merchants where the items may be purchased, even direct linking to the products themselves.

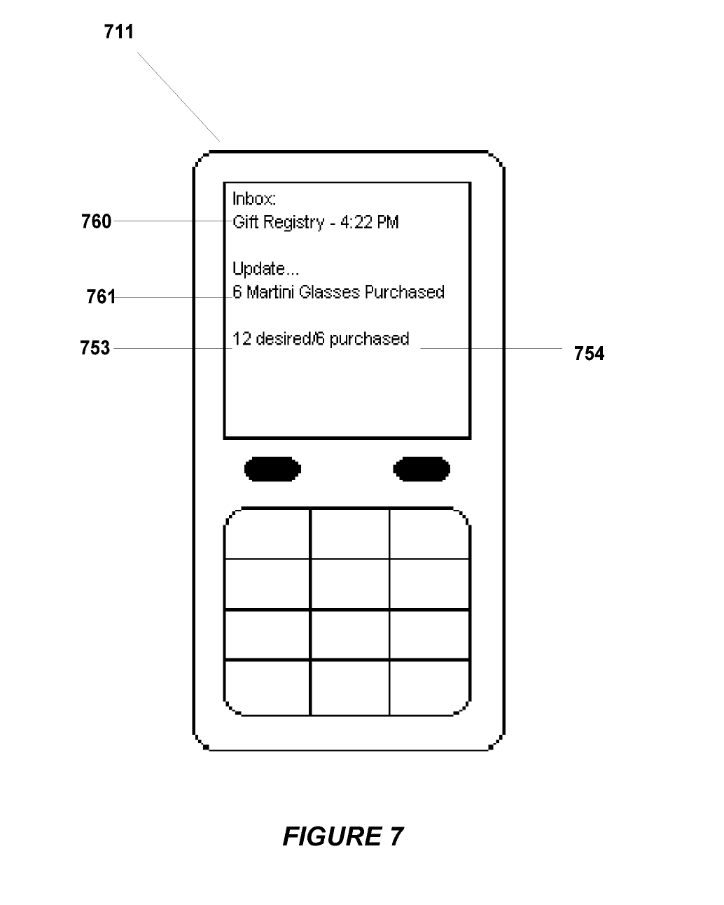

FIG. 7 shows an exemplary embodiment of the notification system. In this embodiment, the registered party elects to receive notification when items have been purchased. As an item is purchased from the registry, an e-mail or text message notification is sent to the registered party. In the case of a text message, this notification is sent directly to the registered party's mobile phone. In the case of e-mail, the notification is sent to the registered party's e-mail address (which may optionally be on or accessible by a mobile phone). The registered party may select the type of notification she wishes to receive or may choose not to be notified. In the figure, the user is notified by text message from the gift registry 760 on her mobile phone 711. The notification states that six martini glasses have just been purchased 761. The notification also states that of the twelve martini glasses desired 753, six have now been purchased 754.

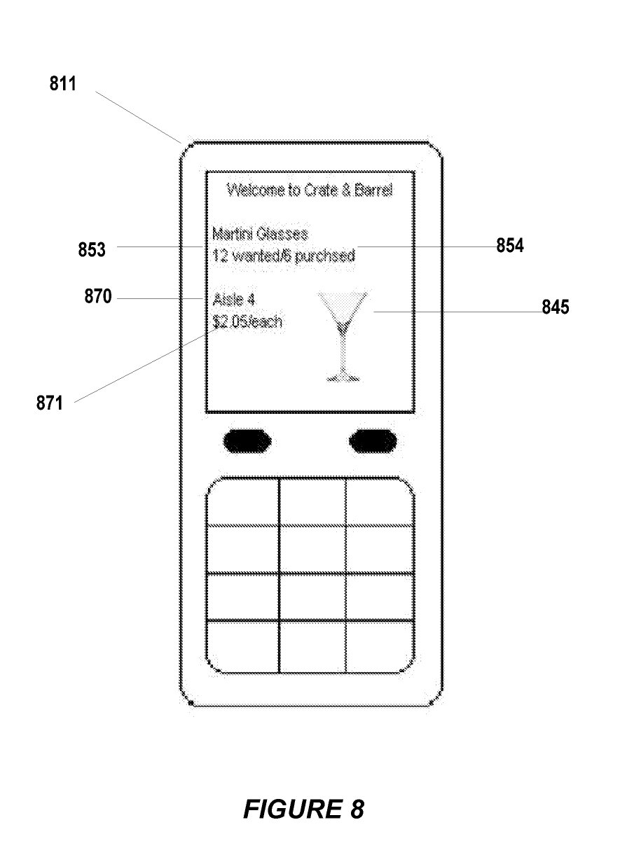

FIG. 8 shows an exemplary embodiment of the notification received by a user. In this embodiment, the user who has joined the system walks into a participating store with her cell phone. As she enters the store, the store detects the presence of her mobile phone. This can be accomplished in any way, including using BLUETOOTH technology or Assisted GPS. The store may then send to her mobile phone 811 a notification detailing the status of registries she has registered with. This notification includes items still available for purchase at that store and can include the price of the item and its location within the store. For example, the notification may inform the user that martini glasses are still available. The pictured notification alerts the user that twelve martini glasses are desired 853 and only six have been purchased 854. The notification includes the price of the item 871, the location 870, for example aisle, in which the martini glasses are located, and a picture of the martini glasses 845. This allows the user to easily locate the item for purchase.

In another embodiment of the present invention, the user utilizes the system to comparison shop through the technique described above and the accompanying figures. The user retrieves data concerning the product she wishes to compare other products with. This may include taking a picture of the item, taking a picture of the barcode, scanning the barcode, scanning an RFID chip, or other means of gaining data. The user sends the data to the server. When the user later logs-in to the registry website, she can select the product for comparison. This will transfer her to a page where she can see product information, including such aspects as size, available colors, etc. The page also includes similar products which are relatively comparable to the original product as well as prices and specifications for each.

For example, the user may take a picture of a sofa she likes at a store or anywhere else. She sends this photo to the server which adds it to her registry. Embodiments of the invention allow the invention to determine the approximate size of the sofa which she has photographed using image recognition software. Later, the user logs into the website and selects this product from the list created for her. The website presents to the user information such as the available dimensions and colors of the sofa. The website shows the user similarly styled sofas along with their available sizes, colors, and prices. This allows the user to comparison shop without having to travel to different stores, writing down product information at each. If the user likes one of the products listed, she can select the link to the product and purchase the product online, if it is available this way.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An item registry, comprising:
a mobile communication device, wherein the mobile communication device is used to capture identity of a product;
a server, wherein the mobile communication device uploads the identity of the product to the server; and
a database linked to the server, wherein the database contains a variety of information of products.

2. The item registry of claim 1, wherein the server creates a list containing the product which expands as a second product is uploaded.

3. The item registry of claim 2, wherein the server hosts a website.

4. The item registry of claim 3, wherein the website allows a user to select a product from the list and retrieve product information from the database.

5. The item registry of claim 4, wherein the product information includes any or all of:
a best price;
an alternative product; and
an available upgrade.

6. The item registry of claim 1, wherein the mobile communications device is a cellular phone.

7. The item registry of claim 6, wherein the cellular phone has a digital camera function.

8. The item registry of claim 7, wherein the digital camera function can capture the product's identity.

9. The item registry of claim 7, wherein the product's identity is captured as a picture of the product.

10. The item registry of claim 7, wherein the product's identity is captured as a picture of the barcode of the product.

11. The item registry of claim 6, wherein the cellular phone further comprises a barcode scanner.

12. The item registry of claim 6, wherein the cellular phone further comprises a RFID scanner.

13. A method of creating a gift registry, the method comprising:
signing up for a registry service;
capturing an identity of a product which a user desires to add to the user's registry, wherein the capturing is accomplished with a mobile device; and
uploading the identity of the product to a server.

14. The method of claim 13, wherein the capturing further comprises using a cellular phone to take a digital photograph of the product.

15. The method of claim 13, wherein the capturing further comprises using a cellular phone to take a digital photograph of a barcode of the product.

16. The method of claim 13, wherein the capturing further comprises using a cellular phone to scan a barcode of the product.

17. The method of claim 13, wherein the capturing further comprises using mobile communications device to scan an RFID identification tag.

18. The method of claim 13, wherein the uploading is accomplished by connecting the mobile device to the internet.

19. The method of claim 13, wherein the uploading is accomplished by sending a text message to the server.

20. The method of claim 13, wherein the signing up further comprises:
entering an identification; and
choosing a password to use along with the identification as a log-in to the server.

21. The method of claim 20, further comprising choosing settings.

22. The method of claim 21, wherein the settings include any or more of:
a notification setting;
a guest list; and
a layout.
